(19) United States
(12) Patent Application Publication
(10) Pub. No.: US 2014/0019586 A1
(43) Pub. Date: Jan. 16, 2014

(54) METHODS FOR FORMAT PRESERVING AND DATA MASKING AND DEVICES THEREOF

(71) Applicant: Infosys Limited, Bangalore (IN)

(72) Inventors: Ashutosh Saxena, Hyderabad (IN); Malakondayya Choudary Gorantla, Parvathipuram (IN); Ravi Sankar Veerubhotla, Hyderabad (IN); Shikha Gupta, New Delhi (IN); Ina Jain, Jaipur (IN)

(21) Appl. No.: 13/938,380

(22) Filed: Jul. 10, 2013

(30) Foreign Application Priority Data
Jul. 13, 2012 (IN) 2866/CHE/2012

(51) Int. Cl. H04L 29/08

(52) U.S. Cl. CPC H04L 67/10
USPC 709/217

(57) ABSTRACT

A method, non-transitory computer readable medium and data masking device comprising receiving an input string comprising one or more input characters from a client computing device. A first numeric value is mapped for each of the one or more input characters of the received input string based on one or more stored datasets. Each of the mapped first numeric values are masked using the one or more stored datasets for each of the one or more input characters of the received input string to a second numeric value. A masked character for each of the second numeric values is remapped based on the one or more stored datasets. The determined masked characters are provided to the requesting client computing device.

This application claims the benefit of Indian Patent Application Filing No. 2866/CHE/2012, filed Jul. 13, 2012, which is hereby incorporated by reference in its entirety.

### FIELD

This technology generally relates to data security, more particularly, to methods for format preserving data masking and devices thereof.

### BACKGROUND

As more and more business transactions occur electronically every year, organizations are forced to retain a growing volume of sensitive data. The ease at which this data can be automatically collected, stored in databases, efficiently queried and obtained over the Internet has raised numerous ethical and legal concerns. These concerns include preventing this data from falling into malicious hands for purposes, such as identity theft, stalking on the web and spam.

Data masking is a process where information in a database is masked or “de-identified”. It enables creation of realistic data in non-production environments without the risk of exposing sensitive information to unauthorized users. Data masking assists with the protection of this growing volume of sensitive data from a multitude of threats posed both outside and inside the organizations perimeter.

Unfortunately, existing technologies perform data masking without preserving data format. Additionally, these existing technologies do not support reverse data masking. Further, data masking requires a high initial capital outlay as development and special hardware is required to run these data masking applications.

### SUMMARY

A method for data masking while preserving format includes a data masking computing device receiving an input string comprising one or more input characters from a client computing device. A first numeric value is mapped by the data masking computing device for each of the one or more input characters of the received input string based on one or more stored datasets. Each of the mapped first numeric values are masked by the data masking computing device using the one or more stored datasets for each of the one or more input characters of the received input string to a second numeric value. A masked character for each of the second numeric values is remapped by the data masking computing device based on the one or more stored datasets. The data masking computing device provides the determined masked characters to the requesting client computing device.

A non-transitory computer readable medium having stored thereon instructions for data masking while preserving includes receiving an input string comprising one or more input characters from a client computing device. A first numeric value is mapped for each of the one or more input characters of the received input string based on one or more stored datasets. Each of the mapped first numeric values are masked using the one or more stored datasets for each of the one or more input characters of the received input string to a second numeric value. A masked character for each of the second numeric values is remapped based on the one or more stored datasets. The determined masked characters are provided to the requesting client computing device.

A data masking computing device comprising at least one of configurable hardware logic configured to be capable of implementing or a processor coupled to a memory and configured to execute programmed instructions stored in the memory including receiving an input string comprising one or more input characters from a client computing device. A first numeric value is mapped for each of the one or more input characters of the received input string based on one or more stored datasets. Each of the mapped first numeric values are masked using the one or more stored datasets for each of the one or more input characters of the received input string to a second numeric value. A masked character for each of the second numeric values is remapped based on the one or more stored datasets. The determined masked characters are provided to the requesting client computing device.

This technology provides a number of advantages including providing more effective methods, non-transitory computer readable medium and devices for preserving format with data masking and reverse data masking. Additionally, with this technology, data is secured with reversible data masking while still retaining the format of the original data.

### BRIEF DESCRIPTION OF THE DRAWINGS

FIG. 1 is an exemplary network environment which comprises a data masking computing device for data masking;

FIG. 2 is a flowchart of an exemplary method for data masking;

FIG. 3 is a flowchart of an exemplary method for reverse data masking;

FIG. 4 is an illustration of exemplary data set;

FIG. 5 is an exemplary data masking process; and

FIG. 6 is an exemplary reverse data masking process.

### DETAILED DESCRIPTION

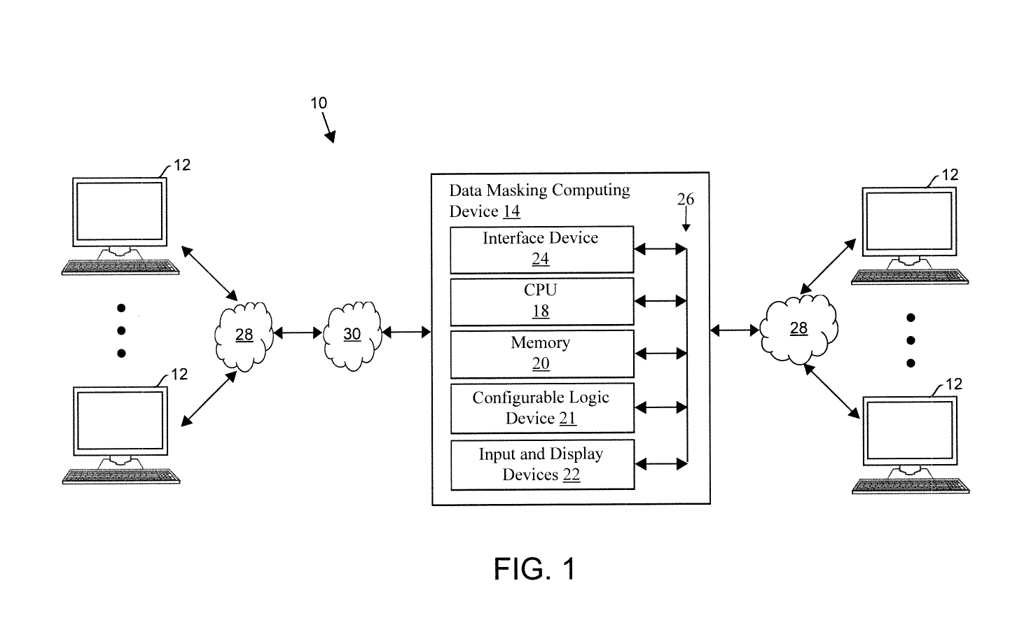

An exemplary environment 10 with a data masking computing device 14 for format preserving and data masking is illustrated in FIG. 1. The exemplary environment 10 includes client computing devices 12 and the data masking computing device 14 which are coupled together by the Local Area Network (LAN) 28 and Wide Area Network (WAN) 30, although the environment 10 can include other types and numbers of devices, components, elements and communication networks in other topologies and deployments. While not shown, the exemplary environment 10 may include additional components, such as routers, switches and other devices which are well known to those of ordinary skill in the art and thus will not be described here. This technology provides a number of advantages including providing more effective methods, non-transitory computer readable medium and devices for format preserving data and formatting with data masking and reverse data masking.

Referring more specifically to FIG. 1, data masking computing device 14 interacts with the client computing devices 12 through the LAN 28 and WAN 30 although the data masking computing device 14 can interact with the client computing devices 12 using any other network topologies. Additionally, the data masking computing device 14 can be hosted on a cloud or could be provided as a service.

The data masking computing device 14 preserves the data format and performs data masking within the environment 10 as illustrated and described with the examples herein, although the data masking computing device 14 may perform other types and numbers of functions. The data masking computing device 14 includes at least one processor 18, memory 20, optional configurable logic 21, input and display devices 22, and interface device 24 which are coupled together by bus 26, although data masking computing device 14 may comprise other types and numbers of elements in other configurations.

Processor(s) 18 may execute one or more computer-executable instructions stored in the memory 20 for the methods illustrated and described with reference to the examples herein, although the processor(s) can execute other types and numbers of instructions and perform other types and numbers of operations. The processor(s) 18 may comprise one or more central processing units (“CPUs”) or general purpose processors with one or more processing cores, such as AMD® processor(s), although other types of processor(s) could be used (e.g., Intel®).

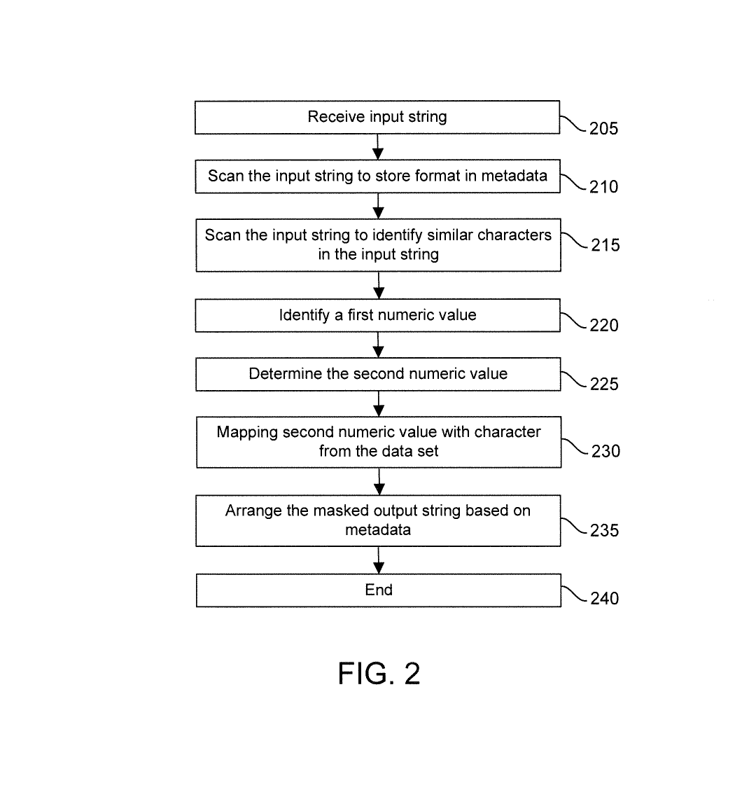

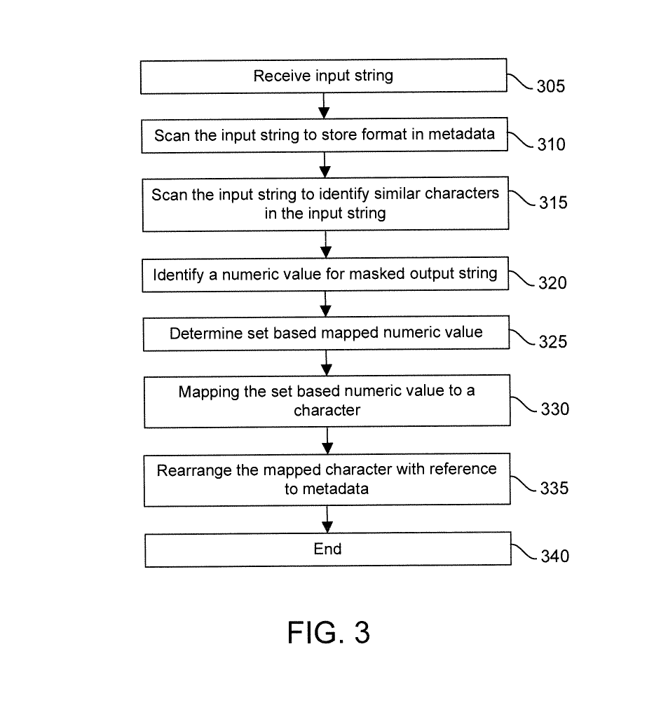

Memory 20 may comprise one or more tangible storage media, such as RAM, ROM, flash memory, CD-ROM, floppy disk, hard disk drive(s), solid state memory, DVD, or any other memory storage types or devices, including combinations thereof, which are known to those of ordinary skill in the art. Memory 20 may store one or more non-transitory computer-readable instructions of this technology as illustrated and described with reference to the examples herein that may be executed by the one or more processor(s) 18. The flow chart shown in FIGS. 2 and 3 is representative of example steps or actions of this technology that may be embodied or expressed as one or more non-transitory computer or machine readable instructions stored in memory 20 that may be executed by the processor(s) 18.

The configurable hardware logic 21 may comprise specialized hardware configured to implement one or more steps of this technology as illustrated and described with reference to the examples herein. By way of example only, the optional configurable hardware logic 21 may comprise one or more of field programmable gate arrays (“FPGAs”), field programmable logic devices (“FPLDs”), application specific integrated circuits (ASICs”) and/or programmable logic units (“PLUs”).

Input and display devices 22 enable a user, such as an administrator, to interact with the data masking computing device 14, such as to input and/or view data and/or to configure, program and/or operate it by way of example only. Input devices may include a touch screen, keyboard and/or a computer mouse and display devices may include a computer monitor, although other types and numbers of input devices and display devices could be used. Additionally, the input and display devices 22 can be used by the user, such as an administrator to develop applications using Application interface.

The interface device 24 in the data masking computing device 14 is used to operatively couple and communicate between the data masking computing device 14 and the client computing devices 12 which are all coupled together by LAN 28 and WAN 30. By way of example only, the interface device 24 can use TCP/IP over Ethernet and industry-standard protocols, including NFS, CIFS, SOAP, XML, LDAP, and SNMP although other types and numbers of communication protocols can be used.

In this example, the bus 26 is a hyper-transport bus, although other bus types and links may be used, such as PCI.

Each of the client computing devices 12 includes a central processing unit (CPU) or processor, a memory, an interface device, and an I/O system, which are coupled together by a bus or other link, although other numbers and types of network devices could be used. Each of the network elements 12 communicate with the data masking computing device 14 through LAN 28, although the network elements 12 can interact with the data masking computing device 14 by any other means.

Although an exemplary environment 10 with the multiple client computing devices 12 and the data masking computing device 14 are described and illustrated herein, other types and numbers of systems, devices in other topologies can be used. It is to be understood that the systems of the examples described herein are for exemplary purposes, as many variations of the specific hardware and software used to implement the examples are possible, as will be appreciated by those skilled in the relevant art(s).

Furthermore, each of the systems of the examples may be conveniently implemented using one or more general purpose computer systems, microprocessors, digital signal processors, and micro-controllers, programmed according to the teachings of the examples, as described and illustrated herein, and as will be appreciated by those of ordinary skill in the art.

The examples may also be embodied as a non-transitory computer readable medium having instructions stored thereon for one or more aspects of the technology as described and illustrated by way of the examples herein, which when executed by a processor (or configurable hardware), cause the processor to carry out the steps necessary to implement the methods of the examples, as described and illustrated herein.

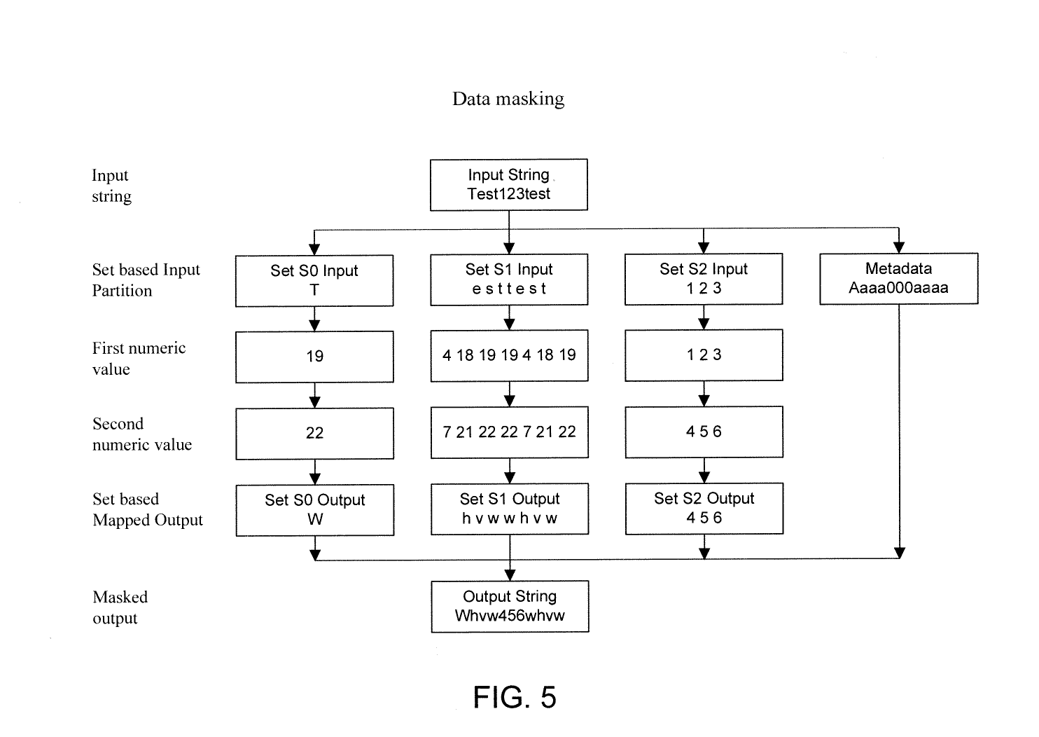

An exemplary method for preserving format with data masking will now be described with reference to FIGS. 1-6. In step 205 in FIG. 2, the data masking computing device 14 receives an input string including alphabetic, numeric and/or special characters for data masking, although the data masking computing device 14 may receive other types of inputs such as image, audio, video files, by way of example only. In this particular example, the data masking computing device 14 receives an input string “Test123test” for data masking shown in FIG. 5 to be used with this illustrative example.

In step 210, the data masking computing device 14 scans the input string to identify different characters of the received input string to store the format of the input string as a metadata in the memory 20. By way of example only, the data masking computing device 14 scans the input string “Test123test” to store the format of the string in the metadata by replacing each character of the received input string with the first character of the corresponding dataset. In this example, all of the capital letters in the received input string are replaced with “A”, all the small letter characters in the received input string by are replaced with “a” and all the numeric characters of the received input string are replaced with “0”. In this illustrative example, the data masking computing device 14 stores “Aaaa000aaaa” as the format in the metadata for further reference as illustrated in FIG. 5, although other manners for storing format could be used. The data masking computing device 14 identifies each character as a capital letter, small letter, numeric character or a special character by their ASCII value although other manners for identifying each character could be used.

In step 215, the data masking computing device 14 scans the input string to identify and perform set based partitioning by grouping similar characters of the received input string. The data masking computing device 14 identifies and groups similar characters by their ASCII value, although other manners for identifying and grouping could be used. By way of example only, the data masking computing device 14 scans the received input string “Test123test” to identify “T” as a capital letter, “esttest” as a group of small letter and “123” as numeric characters in the input string and stores the identified groups in the memory 20 as illustrated in FIG. 5.

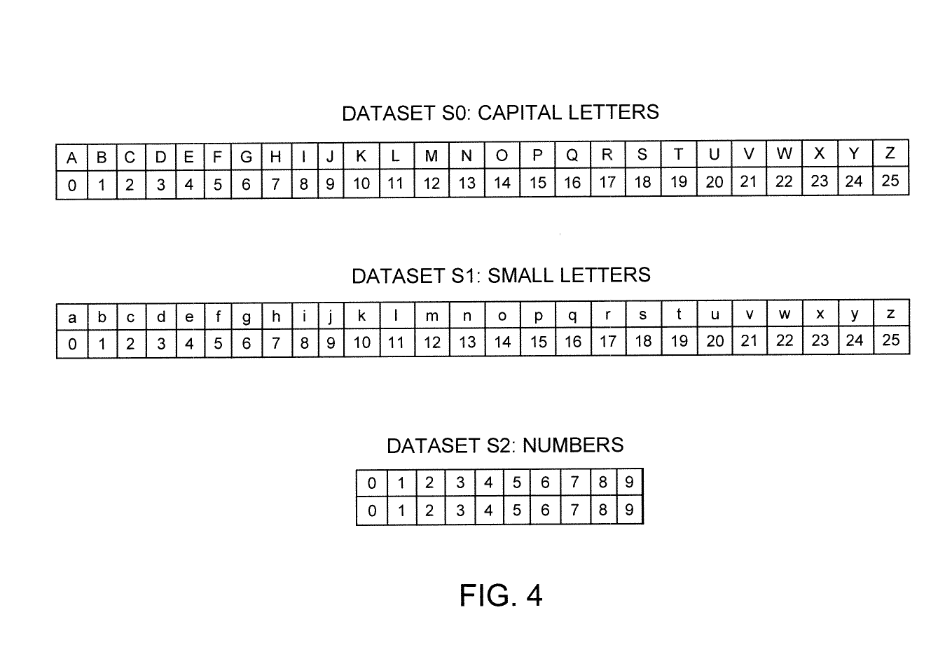

In step 220, the data masking computing device 14 determines a first numeric value associated with each character of the received input string based on one of the stored data sets as illustrated in FIGS. 4 and 5, although other methods or techniques can be used to identify the first numeric value, wherein the first numeric value is a set based mapped input numeric value. By way of example, the data masking computing device 14 identifies the first numeric value associated with capital letter “T” in the received input string “Test123test” by referring to the data set S0 related to capital letter illustrated in FIG. 4. In this illustrative example, the numerical value associated with T is 19 in the data set S0 illustrated in FIG. 4. The data masking computing device 14 identifies the first numeric value associated with “esttest” by referring to data set S1 related to small letters. In this example, the first numeric value associated with small letters “esttest” in the received input string are 4, 18, 19, 19, 4 and 18 as illustrated in FIG. 4. Further, the data masking computing device identifies the first numeric value of the numeric characters “123” of the received input string as 1, 2, and 3 by referring to the data S2 related to the numeric characters illustrated in FIG. 4.

In step 225, the data masking computing device 14 determines a second numeric value for each of the character of the received input string by performing one or more mathematical operations for data masking on each of the determined first numeric values of the received input string illustrated in FIG. 5, although any other methods or techniques can be used to determine the second numeric value. The second numeric value is the set based masked output numeric value. By way of example only, to determine the second numeric value for each of the first numeric value of the received input string, the data masking computing device 14 adds the first numeric value with a pre-defined integer number and performs modulus operations on the added sum with the total number of elements present in the corresponding data set. In this example, the data masking computing device 14 adds the first numeric value 19 with a pre-defined integer 3 to get 22. Further, the data masking computing device 14 performs modulus operation on 22 by dividing it by 26, where 26 is the total number of elements present in the data set S0 illustrated in FIG. 4 to get 22. In this example, 22 is the masked value of the first numeric value 19. Similarly, the data masking computing device 14 determines the second numeric value for the remaining characters of the received input string. By way of example, the second numeric value determining for the remaining characters of the received input string are 7 for first numeric value 4, 21 for first numeric value 18, 22 for first numeric value 19, 22 for first numeric value 19, 7 first numeric value for 4, 21 first numeric value for 18 and 22 for first numeric value 19.

In step 230, the data masking computing device 14 performs mapping on the determined second numeric value with the associated character of the corresponding data set as illustrated in FIGS. 4 and 5, although data masking can be performed in any other methods or techniques. By way of example only, the data masking computing device 14 performs data masking by replacing 22 with “W”, where “W” is the character associated with second numeric value 22 in the data set S0 illustrated in FIG. 4. Further, the data masking computing device 14 replaces 7 with small letter “h”, where “h” is the character associated with 7 in data set S1 illustrated in FIG. 4. Similarly, the data masking computing device 14 replaces 21 with v, 22 with w, 22 with w, 7 with h, 21 with v and 22 with w. Additionally, the data masking computing device 14 replaces 4 with 4, where 4 is the character associated with the second numeric value 4 in the data set S2 illustrated in FIG. 4. Similarly, the data masking computing device 14 replaces 5 with 5 and 6 with 6.

In step 235, the data masking computing device 14 arranges the masked output string back into the same format of the received input string by referring to the metadata stored in step 210. By way of example only, the data masking computing device 14 arranges the masked output string as “Whvwwhvw456” as “Whvw456whvw” by referring to the format of the metadata “Aaaa000aaaa” as illustrated in FIG. 5.

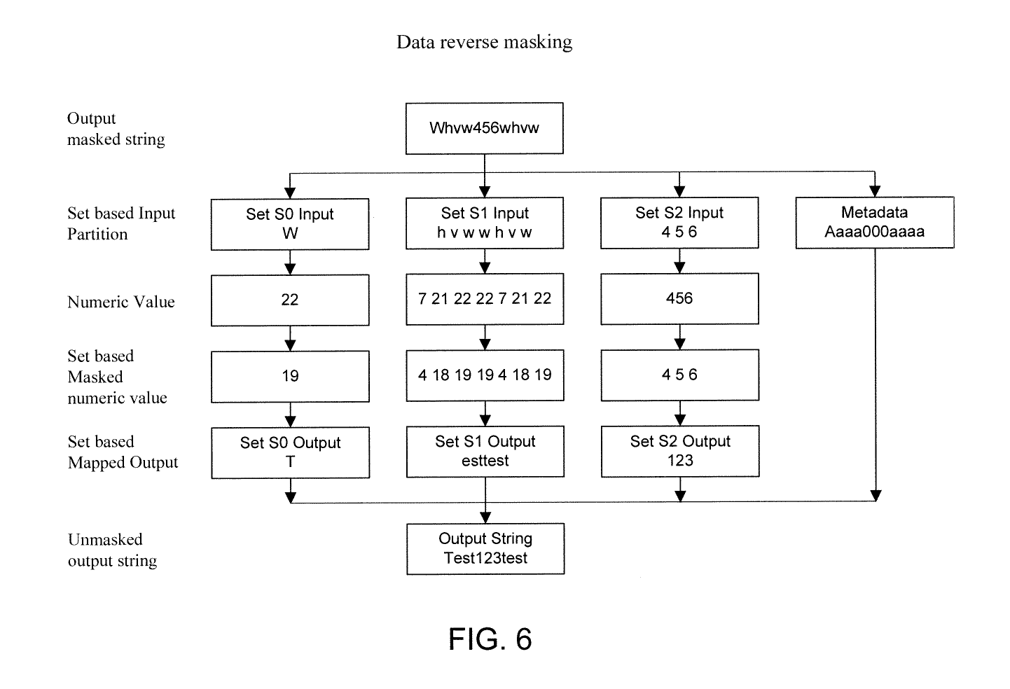

With reference to FIG. 3, in step 305, the data masking computing device 14 begins the reverse data masking process by receiving the masked output string. By way of example only, the masked output string is “Whvw456whvw” as illustrated in FIG. 6.

In step 310, the data masking computing device 14 scans the masked output string to identify different characters of the received masked output string and to store the format of the input string as a metadata in the memory 20 as previously explained in step 210, although other manner for storing format could be used.

In step 315, the data masking computing device 14 scans the output masked string to identify and perform set based partition by grouping similar characters of the received input string as previously explained in step 215.

In step 320, the data masking computing device 14 identifies the numeric value associated with each character of the masked output string “Whvw456whvw” as illustrated in FIGS. 4 and 6. The data masking computing device 14 refers to the data sets S0, S1 and S2 present within the memory 20 to identify the numeric values associated with each character of the output masked string. Additionally, the memory 20 present in the data masking computing device 14 can include additional data sets. By way of example only, the data masking computing device 14 identifies the numeric value associated with “W” from data set S0 illustrated in FIGS. 4 and 6 as 22. Further, the data masking computing device 14 identifies the numeric value for h as 7, v as 21, w as 22, w as 22, h as 7, v as 21 and w as 22 by referring to data set S1 illustrated in FIGS. 4 and 6 and identifying numeric value for 4 as 4, 5 as 5 and 6 as 6 from the data set S2 illustrated in FIGS. 4 and 6.

In step 325, the data masking computing device 14 determines the set based mapped numeric value by performing one or more mathematical operations, although the set based numeric value can be determined by any other methods or techniques. The data masking computing device 14 subtracts each of the numeric value identified in step 305 with a pre-defined integer value and then performs modulus with the total number of elements present in the corresponding dataset associated with the character and the numeric value. By way of example only, the data masking computing device 14 subtracts the identified numeric value for W, 22, with 3 to get 19. Further, the data masking computing device 14 performs modulus operation on 19 to divide it by 26; to get 19 as the set based masked numeric value, where 26 is the total number of elements in set S0. Additionally in this example, the data masking computing device 14 determines the set based numeric value for 7, which is the identified numeric value for h, by subtracting 7 with 3 to get 4 and performing modulus operation by dividing 4 by 26 to get 4. Similarly, the data masking computing device 14 determines the set based numeric value for each of the remaining characters of the masked output string such as 18 for 21, 19 for 22, 19 for 22, 4 for 4, 18 for 21 and 19 for 22 as illustrated in FIG. 6.

In step 330, the data masking computing device 14 maps the set based numeric value to the associated character by referring to the corresponding data set. By way of example only, the data masking computing device 14 maps the determined set based numeric value 19 to “T” by referring to the dataset S0 illustrated in FIGS. 4 and 6. Additionally, the data masking computing device 14 refers to the metadata stored in the memory 20 to identify the dataset to which the data masking computing device 14 has to refer to. Further, the data masking computing device 14 maps the determined set based numeric value 4 to “e” by referring to data set S1 illustrated in FIGS. 4 and 6. Similarly, the data masking computing device 14 maps each of the remaining set based masked numeric value to the associated character in the data set; 18 is mapped to “s”, 19 is mapped to “t”, 19 is mapped to “t”, 4 is mapped to “e”, 18 is mapped to “s” and 19 is mapped to “t” as illustrated in FIG. 6.

In step 335, the data masking computing device 14 rearranges the mapped characters to the format of the input string by referring to the metadata stored in the memory 20. By way of example only, the data masking computing device 14 rearranges “Testtest123” to “Test123test” by referring to the format “Aaaa000aaaa” stored in the metadata.

In the example described above, the data masking computing device 14 maps each character of the input string to a numeric value while masking and maps the numeric value to a character in reverse masking, thereby, retaining the format and the structure of the data.

This technology provides a number of advantages including providing more effective methods, non-transitory computer readable medium, and devices for preserving format with data masking and reverse data masking. Additionally, with this technology data the format of the original data is maintained throughout the masking and reverse masking processes. Further, this technology can be accessed and utilized from a variety of different types of platforms and applications at a low implementation and maintenance cost.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method for data masking while preserving format, the method comprising:
receiving by a data masking computing device an input string comprising one or more input characters from a client computing device;
mapping by the data masking computing device a first numeric value for each of the one or more input characters of the received input string based on one or more stored datasets;
applying masking by the data masking computing device using the one or more stored datasets for each of the determined first numeric values for each of the one or more input characters of the received input string to a second numeric value;
remapping by the data masking computing device a masked character for each of the second numeric values based on the one or more stored datasets; and
providing by the data masking computing device the determined masked characters to the requesting client computing device.

2. The method as set forth in claim 1 further comprising identifying by the data masking computing device one of a plurality of types of input characters for each of the one or more input characters of the received input string.

3. The method as set forth in claim 2 further comprising generating by the data masking computing device metadata comprising a format for each of the one or more input characters of the received input string based on the identified one of the plurality of types of input characters for each of the one or more input characters of the received input string.

4. The method as set forth in claim 3 further comprising adjusting by the data masking computing device an order of the determined mapped characters based on the metadata.

5. The method as set forth in claim 2 wherein each of the plurality of types of input characters has one of the one or more stored datasets.

6. The method as set forth in claim 1 further comprising
receiving by the data masking computing device the determined masked characters from the client computing device;
mapping by the data masking computing device the second numeric value for each of the masked characters based on the one or more stored datasets;
applying reverse masking by the data masking computing device using the stored one or more datasets for each of the determined second numeric values to one of the first numeric values;
remapping by the data masking computing device the one of the one or more input characters of the received input string from each of the first numeric values based on one or more stored datasets; and
providing by the data masking computing device the input string comprising the one or more input characters to the client computing device.

7. The method as set forth in claim 6 further comprising:
obtaining by the data masking computing device metadata of the format for each of the one or more input characters of the received input string; and
adjusting by the data masking computing device an order of the one or more input characters based on the obtained metadata.

8. A non-transitory computer readable medium having stored thereon instructions for data masking while preserving format comprising machine executable code which when executed by at least one processor, causes the processor to perform steps comprising:
receiving an input string comprising one or more input characters from a client computing device;
mapping a first numeric value for each of the one or more input characters of the received input string based on one or more stored datasets;
applying masking using the one or more stored datasets for each of the determined first numeric values for each of the one or more input characters of the received input string to a second numeric value;
remapping a masked character for each of the second numeric values based on the one or more stored datasets; and
providing the determined masked characters to the requesting client computing device.

9. The medium as set forth in claim 8 further comprising identifying one of a plurality of types of input characters for each of the one or more input characters of the received input string.

10. The medium as set forth in claim 9 further comprising generating metadata comprising a format for each of the one or more input characters of the received input string based on the identified one of the plurality of types of input characters for each of the one or more input characters of the received input string.

11. The medium as set forth in claim 10 further comprising adjusting an order of the determined mapped characters based on the metadata.

12. The medium as set forth in claim 9 wherein each of the plurality of types of input characters has one of the one or more stored datasets.

13. The medium as set forth in claim 8 further comprising:
receiving the determined masked characters from the client computing device;
mapping the second numeric value for each of the masked characters based on the one or more stored datasets;
applying reverse masking using the one or more stored datasets for each of the determined second numeric values to one of the first numeric values;
remapping the one of the one or more input characters of the received input string from each of the first numeric values based on one or more stored datasets; and
providing the input string comprising the one or more input characters to the client computing device.

14. The medium as set forth in claim 13 further comprising:
obtaining metadata of the format for each of the one or more input characters of the received input string; and
adjusting an order of the one or more input characters based on the obtained metadata.

15. A data masking computing device comprising:
at least one of configurable hardware logic configured to be capable of implementing or a processor coupled to a memory and configured to execute programmed instructions stored in the memory comprising:
receiving an input string comprising one or more input characters from a client computing device;
mapping a first numeric value for each of the one or more input characters of the received input string based on one or more stored datasets;
applying masking using the one or more stored datasets for each of the determined first numeric values for each of the one or more input characters of the received input string to a second numeric value;
remapping a masked character for each of the second numeric values based on the one or more stored datasets; and
providing the determined masked characters to the requesting client computing device.

16. The device as set forth in claim 15 wherein the at least one of configurable hardware logic configured to be capable of implementing or the processor coupled to the memory and configured to execute programmed instructions stored in the memory further comprising identifying one of a plurality of types of input characters for each of the one or more input characters of the received input string.

17. The device as set forth in claim 16 wherein the at least one of configurable hardware logic configured to be capable of implementing or the processor coupled to the memory and configured to execute programmed instructions stored in the memory further comprising generating metadata comprising a format for each of the one or more input characters of the received input string based on the identified one of the plurality of types of input characters for each of the one or more input characters of the received input string.

18. The device as set forth in claim 17 wherein the at least one of configurable hardware logic configured to be capable of implementing or the processor coupled to the memory and configured to execute programmed instructions stored in the memory further comprising adjusting an order of the determined mapped characters based on the metadata.

19. The device as set forth in claim 16 wherein each of the plurality of types of input characters has one of the one or more stored datasets.

20. The device as set forth in claim 15 wherein the at least one of configurable hardware logic configured to be capable of implementing or the processor coupled to the memory and configured to execute programmed instructions stored in the memory further comprising:
receiving the determined masked characters from the client computing device;
mapping the second numeric value for each of the masked characters based on the one or more stored datasets;
applying reverse masking using the stored one or more datasets for each of the determined second numeric values to one of the first numeric values;
remapping the one of the one or more input characters of the received input string from each of the first numeric values based on one or more stored datasets; and
providing the input string comprising the one or more input characters to the client computing device.

21. The device as set forth in claim 20 wherein the at least one of configurable hardware logic configured to be capable of implementing or the processor coupled to the memory and configured to execute programmed instructions stored in the memory further comprising:
obtaining metadata of the format for each of the one or more input characters of the received input string; and
adjusting an order of the one or more input characters based on the obtained metadata.
